(19) United States
(12) Patent Application Publication
(10) Pub. No.: US 2023/0146958 A1
(43) Pub. Date: May 11, 2023

(54) NEW SOLID SULFIDE ELECTROLYTES

(71) Applicant: Solvay SA, Brussels (BE)

(72) Inventors: Lauriane D'Alencon, Issy-Les-Moulineaux (FR); Thierry Le Mercier, Rosny-sous-Bois (FR); Marc-David Braida, Bry-Sur-Marne (FR)

(73) Assignee: Solvay SA, Brussels (BE)

(21) Appl. No.: 17/914,240

(22) PCT Filed: Mar. 18, 2021
(86) PCT No.: PCT/EP2021/057020

§ 371 Date: Sep. 23, 2022

(30) Foreign Application Priority Data
Mar. 23, 2020 (EP) 20164967.0

(51) Int. Cl. C01G 3/00; H01M 10/0562; H01M 4/58; H01M 50/446

(52) U.S. Cl. CPC C01G 3/006; H01M 4/5815; H01M 10/0562; H01M 50/446; C01P 2002/72; C01P 2004/61; C01P 2004/62; C01P 2006/40; H01M 2220/20; H01M 2300/0068

(57) ABSTRACT

The present invention concerns a method for producing a solid material according to general formula (I) as follows: Li₆₋ₓ__{2y}CuₓPS₅__{y}X (I) wherein X is selected from the group consisting of: F, CI, I and Br; 0.005 ≤ x ≤ 5; and 0 ≤y ≤ 0.5.; comprising at least bringing at least lithium sulfide, phosphorous sulfide, halogen compound and a copper compound, optionally in one or more solvents. The invention also refers to said solid materials and their use as solid electrolytes notably for electrochemical devices.

This application claims priority filed on 23 Mar. 2020 in EUROPE with Nr 20164967.0, the whole content of this application being incorporated herein by reference for all purposes.

The present invention concerns a method for producing a solid material according to general formula (I) as follows:

$${\text{Li}}_{6 \text{-x-2y}} {\text{Cu}}_{\text{x}} {\text{PS}}_{5 \text{-y}} \text{X}$$

wherein X is halogen, 0.005 ≤ x ≤ 5; and 0 ≤ y ≤ 0.5; comprising at least bringing at least lithium sulfide, phosphorous sulfide, halogen compound and a copper compound, optionally in one or more solvents. The invention also refers to said solid materials and their use as solid electrolytes notably for electrochemical devices.

### PRIOR ART

Lithium batteries are used to power portable electronics and electric vehicles owing to their high energy and power density. Conventional lithium batteries make use of a liquid electrolyte that is composed of a lithium salt dissolved in an organic solvent. The aforementioned system raises security questions as the organic solvents are flammable. Lithium dendrites forming and passing through the liquid electrolyte medium can cause short circuit and produce heat, which result in accident that leads to serious injuries. Since the electrolyte solution is a flammable liquid, there is a concern of occurrence of leakage, ignition or the like when used in a battery. Taking such concern into consideration, development of a solid electrolyte having a higher degree of safety is expected as an electrolyte for a next-generation lithium battery.

Non-flammable inorganic solid electrolytes offer a solution to the security problem. Furthermore, their mechanic stability helps suppressing lithium dendrite formation, preventing self-discharge and heating problems, and prolonging the life-time of a battery.

Solid sulfide electrolytes are advantageous for lithium battery applications due to their high ionic conductivities and mechanical properties. These electrolytes can be pelletized and attached to electrode materials by cold pressing, which eliminates the necessity of a high temperature assembly step. Elimination of the high temperature sintering step removes one of the challenges against using lithium metal anodes in lithium batteries. Due to the wide-spread use of all solid state lithium batteries, there is an increasing demand for solid state electrolytes having a high conductivity for lithium ions. An important class of such solid electrolytes are materials of the composition Li₆PS₅X (X = Cl, Br) which have an argyrodite structure. Argyrodites have long been known and are derived from argyrodite Ag₈GeS₆, which was described for the first time in 1886 by C. Winkler and the analysis of which led to the discovery of germanium. The argyrodite family consists of more than 100 crystalline solids and includes, for example, those solid-state compounds in which the silver is replaced by copper, the germanium by gallium or phosphorus and the sulfur by selenium. Thus, Nitsche, Kuhs, Krebs, Evain, Boucher, Pfitzner and Nilges describe, inter alia, compounds such as Cu₉GaS₆, Ag₇PSe₆ and Cu₈GaS₅Cl, the solid-state structures of which are derived from argyrodite.

Most of the lithium argyrodites, and in particular most of the Li₆PS₅Cl, as reported in the literature, are prepared via a dry or wet mechanochemical route.

There is however a need for new solid sulfide electrolytes having optimized performances, such as higher ionic conductivity and lower activation energy, without compromising other important properties like chemical and mechanical stability.

### INVENTION

Surprisingly it has been found that new solid sulfide electrolytes having higher ionic conductivity and lower activation energy in comparison with usual Li₆PS₅Cl materials may be obtained by using copper dopant. The new LiCuPSX solid materials of the invention also exhibits at least similar chemical and mechanical stability and processability like those conventional lithium argyrodites. Solid materials of the invention may also be prepared with improved productivity and allowing a control of the morphology of the obtained product. Furthermore, solid materials of the invention exhibit a lower amount of raw materials impurity, such as Li₂S and LiCl impurity. Solid materials of the invention exhibit also a lower amount of undesired phases, such as Gamma-Li₃PS₄.

The present invention refers then to a solid material according to general formula (I) as follows:

$${\text{Li}}_{6 \text{-x-2y}} {\text{Cu}}_{\text{x}} {\text{PS}}_{5 \text{-y}} \text{X}$$

wherein:
X is selected from the group consisting of: F, Cl, I and Br;
0.005 ≤ x ≤ 5; preferably 0.015 ≤ x ≤ 1.5; and
0 ≤ y ≤ 0.5, preferably 0 ≤ y ≤ 0.25.

The invention also concerns a method for producing a solid material according to general formula (I) as follows:

$${\text{Li}}_{6 \text{-x-2y}} {\text{Cu}}_{\text{x}} {\text{PS}}_{5 \text{-y}} \text{X}$$

wherein:
X is selected from the group consisting of: F, Cl, I and Br;
0.005 ≤ x ≤ 5; preferably 0.015 ≤ x ≤ 1.5; and
0 ≤ y ≤ 0.5, preferably 0 ≤ y ≤ 0.25;
comprising at least bringing at least lithium sulfide, phosphorous sulfide, halogen compound and a copper compound, optionally in one or more solvents.

The invention also refers to a process for the preparation of a solid material according to general formula (I) as follows:

$${\text{Li}}_{6 \text{-x-2y}} {\text{Cu}}_{\text{x}} {\text{PS}}_{5 \text{-y}} \text{X}$$

wherein:
X is selected from the group consisting of: F, Cl, I and Br;
0.005 ≤ x ≤ 5; preferably 0.015 ≤ x ≤ 1.5; and
0 ≤ y ≤ 0.5, preferably 0 ≤ y ≤ 0.25;
said process comprising at least the process steps of:
a) obtaining a composition by admixing stoichiometric amounts of lithium sulfide, phosphorous sulfide, halogen compound and a copper compound, optionally in one or more solvents, under an inert atmosphere;
b) applying a mechanical treatment to the composition obtained in step a);
c) optionally removing at least a portion of the one or more solvents from the composition obtained on step b), so that to obtain a solid residue;
d) heating the obtained residue obtained in step c) at a temperature in the range of from 100° C. to 700° C., under an inert atmosphere, thereby forming the solid material; and
e) optionally treating the solid material obtained in step d) to the desired particle size distribution.

The invention furthermore concerns a solid material susceptible to be obtained by said first process.

Solid materials of the invention may also be produced by a full solution method. Notably the invention also refers to a process for the preparation of a solid material according to general formula (I), as follows:

$${\text{Li}}_{6 \text{-x-2y}} {\text{Cu}}_{\text{x}} {\text{PS}}_{5 \text{-y}} \text{X}$$

wherein:
X is selected from the group consisting of: F, Cl, I and Br;
0.005 ≤ x ≤ 5; preferably 0.015 ≤ x ≤ 1.5; and
0 ≤ y ≤ 0.5, preferably 0 ≤ y ≤ 0.25;
said process comprising at least the process steps of:
a′) obtaining a solution by admixing stoichiometric amounts of lithium compounds, sulfide compounds, phosphorous compounds, halogen compound and a copper compound, in one or more solvents, under an inert atmosphere;
b′) removing at least a portion of the one or more solvents from the composition as obtained in step a′), so that to obtain a solid material; preferably at a temperature in the range of from 30° C. to 200° C., under an inert atmosphere;
c′) optionally heating the solid material as obtained in step b′), at a temperature in the range of from 100° C. to 700° C., under an inert atmosphere; and
d′) optionally treating the solid material obtained in step c′) to the desired particle size distribution.

The invention furthermore concerns a solid material susceptible to be obtained by said second process.

The invention also refers to the use of a solid material of formula (I) as follows:

$${\text{Li}}_{6 \text{-x-2y}} {\text{Cu}}_{\text{x}} {\text{PS}}_{5 \text{-y}} \text{X}$$

wherein:
X is selected from the group consisting of: F, Cl, I and Br;
0.005 ≤ x ≤ 5; preferably 0.015 ≤ x ≤ 1.5; and
0 ≤ y ≤ 0.5, preferably 0 ≤ y ≤ 0.25;
as solid electrolyte.

The invention also refers to a solid electrolyte comprising at least a solid material of formula (I) as follows:

$${\text{Li}}_{6 \text{-x-2y}} {\text{Cu}}_{\text{x}} {\text{PS}}_{5 \text{-y}} \text{X}$$

wherein:
X is selected from the group consisting of: F, Cl, I and Br;
0.005 ≤ x ≤ 5; preferably 0.015 ≤ x ≤ 1.5; and
0 ≤ y ≤ 0.5, preferably 0 ≤ y ≤ 0.25.

The invention also concerns an electrochemical device comprising at least a solid electrolyte comprising at least a solid material of formula (I) as follows:

$${\text{Li}}_{6 \text{-x-2y}} {\text{Cu}}_{\text{x}} {\text{PS}}_{5 \text{-y}} \text{X}$$

wherein:
X is selected from the group consisting of: F, Cl, I and Br;
0.005 ≤ x ≤ 5; preferably 0.015 ≤ x ≤ 1.5; and
0 ≤ y ≤ 0.5, preferably 0 ≤ y ≤ 0.25.

The invention also refers to a solid state battery comprising at least a solid electrolyte comprising at least a solid material of formula (I) as follows:

$${\text{Li}}_{6 \text{-x-2y}} {\text{Cu}}_{\text{x}} {\text{PS}}_{5 \text{-y}} \text{X}$$

wherein:
X is selected from the group consisting of: F, Cl, I and Br;
0.005 ≤ x ≤ 5; preferably 0.015 ≤ x ≤ 1.5; and
0 ≤ y ≤ 0.5, preferably 0 ≤ y ≤ 0.25.

The present invention also concerns a vehicle comprising at least a solid state battery comprising at least a solid electrolyte comprising at least a solid material of formula (I) as follows:

$${\text{Li}}_{6 \text{-x-2y}} {\text{Cu}}_{\text{x}} {\text{PS}}_{5 \text{-y}} \text{X}$$

wherein:
X is selected from the group consisting of: F, Cl, I and Br;
0.005 ≤ x ≤ 5; preferably 0.015 ≤ x ≤ 1.5; and
0 ≤ y ≤ 0.5, preferably 0 ≤ y ≤ 0.25.

### DEFINITIONS

Throughout this specification, unless the context requires otherwise, the word “comprise” or “include”, or variations such as “comprises”, “comprising”, “includes”, “including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”.

As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

The term “electrolyte” refers in particular to a material that allows ions, e.g., Li⁺, to migrate therethrough but which does not allow electrons to conduct therethrough. Electrolytes are useful for electrically isolating the cathode and anodes of a battery while allowing ions, e.g., Li⁺, to transmit through the electrolyte. The “solid electrolyte” according to the present invention means in particular any kind of material in which ions, for example, Li⁺, can move around while the material is in a solid state.

As used herein, the term “argyrodite,” or “argyrodite crystal” refers to a crystal structure or crystal bonding arrangement. This crystal structure or bonding arrangement is based on the crystal structure for the natural mineral, argyrodite, which is a silver germanium sulfide mineral characterized by the chemical formula Ag₈GeS₆. This crystal structure is also exemplified by the isomorphous argyrodite mineral, Ag₈SnS₆.

As used herein, the term “crystalline phase” refers to a material of a fraction of a material that exhibits a crystalline property, for example, well-defined x-ray diffraction peaks as measured by X-Ray Diffraction (XRD).

As used herein, the term “peaks” refers to (2Θ) positions on the x-axis of an XRD powder pattern of intensity v. degrees (2Θ) which have a peak intensity substantially greater than the background. In a series of XRD powder pattern peaks, the primary peak is the peak of highest intensity which is associated with the compound, or phase, being analyzed. The second primary peak is the peak of second highest intensity. The third primary peak is the peak of third highest intensity.

The term “electrochemical device” refers in particular to a device which generates and/or stores electrical energy by, for example, electrochemical and/or electrostatic processes. Electrochemical devices may include electrochemical cells such as batteries, notably solid state batteries. A battery may be a primary (i.e., single or “disposable” use) battery, or a secondary (i.e., rechargeable) battery.

As used herein, the terms “cathode” and “anode” refer to the electrodes of a battery. During a charge cycle in a Li-secondary battery, Li ions leave the cathode and move through an electrolyte and to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more different sources of power, for example both gasoline-powered and electric-powered vehicles.

### DETAILED INVENTION

The invention then relates to a solid material according to general formula (I)

$${\text{Li}}_{6 \text{-x-2y}} {\text{Cu}}_{\text{x}} {\text{PS}}_{5 \text{-y}} \text{X}$$

wherein:
X is halogen, preferably selected from the group consisting of: F, Cl, I and Br;
0.005 ≤ x ≤ 5; preferably 0.015 ≤ x ≤ 1.5; and
0 ≤ y ≤ 0.5., preferably 0 ≤ y ≤ 0.25..

The solid material of the invention is neutrally charged. It is understood that formula (I) is an empirical formula (gross formula) determined by means of elemental analysis. Accordingly, formula (I) defines a composition which is averaged over all phases present in the solid material.

X is preferably Cl and preferably 0.02 ≤ x ≤ 0.8, more preferably 0.03 ≤ x ≤ 0.6, particularly 0.03 ≤ x ≤ 0.06. More preferably x is 0.01, 0.02, 0.03, 0.04, 0.05, 0.06, 0.07, 0.08, 0.09 and 0.1 or any range made from these values. More preferably y is 0, 0.1, 0.2, 0.3, 0.4 and 0.5. any range made from these values.

The solid material of the invention may be amorphous (glass) and/or crystallized (glass ceramics). Only part of the solid material may be crystallized. The crystallized part of the solid material may comprise only one crystal structure or may comprise a plurality of crystal structures. The crystallization degree of the solid material (the crystallization degree of a crystal structure of which the ionic conductivity is higher than that of an amorphous body) is preferably comprised from 80% to 100%.

The degree of crystallization may be measured by means of an NMR spectrum apparatus. Specifically, the solid ³¹P-NMR spectrum of the solid material is measured, and for the resulting spectrum, the resonance line observed at 70 to 120 ppm is separated into a Gaussian curve by using nonlinear least-squares method, and the ratio of areas of each curve is obtained.

Solid material of the invention preferably comprises a fraction consisting of crystalline phases, wherein one of said crystalline phases has the argyrodite structure. Preferably said crystalline phase having the argyrodite phase makes from 90 to 100% of the total weight of the fraction consisting of crystalline phases. Such a fraction may be measured by X-Ray Diffraction by mean of Rietveld refinement of the total diffractogram. This refinement can be done with FullProf software by using multiphase refinement option.

Solid material of the invention may comprise structural units PS₄³⁻ and structural units PO₄³⁻, wherein preferably the ratio between the amount of structural units PS₄³⁻ and the amount of structural units PO₄³⁻ is in the range from 1000:1 to 9:1. Solid material of the invention may comprise at least peaks at position of: 15.65°+/- 0.5°, 25.53°+/- 0.5°, 30.16°+/- 0.5°, and 31.52°+/- 0.5° (2θ) when analyzed by x-ray diffraction using CuKα radiation at 25° C.

The cristallographic space group of the solid material of the present invention is preferably space group 226 (F43m). In this space group, cell parameters of the solid materials of the present invention may range from 9,680 Angstrom to 9,840 Angstrom, as measured by x-ray diffraction using CuKα radiation at 25° C., and further calculated with a dedicated software, such as Fullprof software, using a refinement method such as Rietveld and Le Bail refinement.

Preferably solid materials of formula (I) according to the present invention may be as follows:

| x | y | Li | Cu | P | S | Cl |
|---|---|---|---|---|---|---|
| 0.015 | 0 | 5.99 | 0.015 | 1 | 5 | 1 |
| 0.03 | 0 | 5.97 | 0.03 | 1 | 5 | 1 |
| 0.06 | 0 | 5.94 | 0.06 | 1 | 5 | 1 |
| 0.3 | 0 | 5.70 | 0.3 | 1 | 5 | 1 |
| 0.6 | 0 | 5.40 | 0.6 | 1 | 5 | 1 |
| 1 | 0 | 5.00 | 1 | 1 | 5 | 1 |
| 1.3 | 0 | 4.70 | 1.3 | 1 | 5 | 1 |
| 1.5 | 0 | 4.50 | 1.5 | 1 | 5 | 1 |
| 0.015 | 0.1 | 5.79 | 0.015 | 1 | 4.9 | 1 |
| 0.03 | 0.1 | 5.77 | 0.03 | 1 | 4.9 | 1 |
| 0.06 | 0.1 | 5.74 | 0.06 | 1 | 4.9 | 1 |
| 0.3 | 0.1 | 5.50 | 0.3 | 1 | 4.9 | 1 |
| 0.6 | 0.1 | 5.20 | 0.6 | 1 | 4.9 | 1 |
| 1 | 0.1 | 4.80 | 1 | 1 | 4.9 | 1 |
| 1.3 | 0.1 | 4.50 | 1.3 | 1 | 4.9 | 1 |
| 1.5 | 0.1 | 4.30 | 1.5 | 1 | 4.9 | 1 |
| 0.015 | 0.2 | 5.59 | 0.015 | 1 | 4.8 | 1 |
| 0.03 | 0.2 | 5.57 | 0.03 | 1 | 4.8 | 1 |
| 0.06 | 0.2 | 5.54 | 0.06 | 1 | 4.8 | 1 |
| 0.3 | 0.2 | 5.30 | 0.3 | 1 | 4.8 | 1 |
| 0.6 | 0.2 | 5.00 | 0.6 | 1 | 4.8 | 1 |
| 1 | 0.2 | 4.60 | 1 | 1 | 4.8 | 1 |
| 1.3 | 0.2 | 4.30 | 1.3 | 1 | 4.8 | 1 |
| 1.5 | 0.2 | 4.10 | 1.5 | 1 | 4.8 | 1 |
| 0.015 | 0.25. | 5.49 | 0.015 | 1 | 4.75 | 1 |
| 0.03 | 0.25. | 5.47 | 0.03 | 1 | 4.75 | 1 |
| 0.06 | 0.25. | 5.44 | 0.06 | 1 | 4.75 | 1 |
| 0.3 | 0.25. | 5.20 | 0.3 | 1 | 4.75 | 1 |
| 0.6 | 0.25. | 4.90 | 0.6 | 1 | 4.75 | 1 |
| 1 | 0.25. | 4.50 | 1 | 1 | 4.75 | 1 |
| 1.3 | 0.25. | 4.20 | 1.3 | 1 | 4.75 | 1 |
| 1.5 | 0.25. | 4.00 | 1.5 | 1 | 4.75 | 1 |

The composition of the compound of formula (I) may notably be determined by chemical analysis using techniques well known to the skilled person, such as for instance a X-Ray Diffraction (XRD) and an Inductively Coupled Plasma-Mass Spectrometry (ICP-MS).

Solid materials of the invention may be in powder form with a distribution of particle diameters having a D50 preferably comprised between 0.05 µm and 10 µm. The particle size can be evaluated with SEM image analysis or laser diffraction analysis.

D50 has the usual meaning used in the field of particle size distributions. Dn corresponds to the diameter of the particles for which n% of the particles have a diameter which is less than Dn. D50 (median) is defined as the size value corresponding to the cumulative distribution at 50%. These parameters are usually determined from a distribution in volume of the diameters of a dispersion of the particles of the solid material in a solution, obtained with a laser diffractometer, using the standard procedure predetermined by the instrument software. The laser diffractometer uses the technique of laser diffraction to measure the size of the particles by measuring the intensity of light diffracted as a laser beam passes through a dispersed particulate sample. The laser diffractometer may be the Mastersizer 3000 manufactured by Malvern for instance.

D50 may be notably measured after treatment under ultrasound. The treatment under ultrasound may consist in inserting an ultrasonic probe into a dispersion of the solid material in a solution, and in submitting the dispersion to sonication.

The invention also refers to a method for producing a solid material according to general formula (I) comprising at least bringing at least lithium sulfide, phosphorous sulfide, halogen compound and a copper compound, optionally in one or more solvents. One or more lithium sulfide, phosphorous sulfide, halogen compound and a copper compound may be used.

Notably, the present invention concerns also a method for producing a solid material according to general formula (I) comprising at least reacting at least lithium sulfide, phosphorous sulfide, halogen compound and a copper compound, optionally in one or more solvents. One or more lithium sulfide, phosphorous sulfide, halogen compound and a copper compound may be used.

Solid materials of the invention may be produced by any methods used in the prior art known for producing a sulfide-based glass solid electrolyte, such as for instance a melt extraction method, a full solution method, a mechanical milling method or a slurry method in which raw materials are reacted, optionally in one or more solvents.

The invention then refers to a process for the preparation of a solid material according to general formula (I), said process comprising at least the process steps of:
a) obtaining a composition by admixing stoichiometric amounts of lithium sulfide, phosphorous sulfide, halogen compound and a copper compound, optionally in one or more solvents, under an inert atmosphere;
b) applying a mechanical treatment to the composition obtained in step a);
c) optionally removing at least a portion of the one or more solvents from the composition obtained on step b), so that to obtain a solid residue;
d) heating the obtained residue obtained in step c) at a temperature in the range of from 100° C. to 700° C., under an inert atmosphere, thereby forming the solid material; and
e) optionally treating the solid material obtained in step d) to the desired particle size distribution.

Inert atmosphere as used in step a) refers to the use of an inert gas; ie. a gas that does not undergo detrimental chemical reactions under conditions of the reaction. Inert gases are used generally to avoid unwanted chemical reactions from taking place, such as oxidation and hydrolysis reactions with the oxygen and moisture in air. Hence inert gas means gas that does not chemically react with the other reagents present in a particular chemical reaction. Within the context of this disclosure the term “inert gas” means a gas that does not react with the solid material precursors. Examples of an “inert gas” include, but are not limited to, nitrogen, helium, argon, carbon dioxide, neon, xenon, H₂S, O₂ with less than 1000 ppm of liquid and airborne forms of water, including condensation. The gas can also be pressurized.

It is preferred that stirring be conducted when the raw materials are brought into contact with each other under an atmosphere of an inert gas such as nitrogen or argon. The dew point of an inert gas is preferably -20° C. or less, particularly preferably -40° C. or less. The pressure may be from 0.0001 Pa to 100 MPa, preferably from 0.001 Pa to 20 MPa, preferably from 0.01 Pa to 0.5 MPa.

Preferably in step a), inert atmosphere comprises an inert gas such as H₂S, dry N₂, dry Argon or dry air (dry may refer to a gas with less than 800 ppm of liquid and airborne forms of water, including condensation).

The composition ratio of each element can be controlled by adjusting the amount of the raw material compound when the solid material is produced. The precursors and their molar ratio are selected according to the target stoichiometry. The target stoichiometry defines the ratio between the elements Li, Cu, P, S and M, which is obtainable from the applied amounts of the precursors under the condition of complete conversion without side reactions and other losses.

Lithium sulfide refers to a compound including one or more of sulfur atoms and one or more of lithium atoms, or alternatively, one or more of sulfur containing ionic groups and one or more of lithium containing ionic groups. In certain preferred aspects, lithium sulfide may consist of sulfur atoms and lithium atoms. Preferably, lithium sulfide is Li₂S.

Phosphorus sulfide refers to a compound including one or more of sulfur atoms and one or more of phosphorus atoms, or alternatively, one or more of sulfur containing ionic groups and one or more of phosphorus containing ionic groups. In certain preferred aspects, phosphorus sulfide may consist of sulfur atoms and phosphorus atoms. Non-limiting exemplary phosphorus sulfide may include, but not limited to, P₂S₅, P₄S₃, P₄S₁₀, P₄S₄, P₄S₅, P₄S₆, P₄S₇, P₄S₈, and P₄S₉.

Halogen compound refers to a compound including one or more of halogen atoms such as F, Cl, Br, or I via chemical bond (e.g., ionic bond or covalent bond) to the other atoms constituting the compound. In certain preferred aspect, the halogen compound may include one or more of F, Cl, Br, I, or combinations thereof and one or more metal atoms. In other preferred aspect, the halogen compound may include one or more of F, Cl, Br, I, or combinations thereof and one or more non-metal atoms. Non-limiting examples may suitably include metal halide such as LiF, LiBr, LiCl, LiI, NaF, NaBr, NaCl, NaI, KaF, KBr, KCl, KI, and the like. In certain preferred aspect, the halogen compound suitably for the use in a solid electrolyte in all-solid Li-ion battery may include one or more halogen atoms and Li. Preferably, the halogen compound may be selected from the group consisting of lithium bromide (LiBr), lithium chloride (LiCl), lithium iodide (LiI) and combinations thereof.

Copper compound refers to a compound including one or more of Cu atoms via chemical bond (e.g., ionic bond or covalent bond) to the other atoms constituting the compound. In another aspect, copper compound can be metallic copper. In certain preferred aspect, the copper compound may include one or more Cu atoms one or more non-metal atoms, such as S, Cl or Br. Copper compounds are preferably chosen in the group consisting of: CuS, Cu₂S, Cu₂₋ₓS (wherein x is comprised between 0 and 1, notably x=0.06 (djurleite), x=0.1, x=0.2 (digenite)) and CuCl₂. Copper compound of the invention may also be a blend of metallic copper and elementary sulfur.

Preferably, the solid material of the invention is made by using at least the precursors as follows: Li₂S, P₂S₅, LiCl and Cu₂S. Lithium sulfide is then Li₂S, phosphorous sulfide is then P₂S₅, halogen compound is then LiCl, and copper compound is then Cu₂S.

Preferably, lithium sulfide, phosphorous sulfide, halogen compound and a copper compound have an average particle diameter comprised between 0.5 µm and 400 µm. The particle size can be evaluated with SEM image analysis or laser diffraction analysis.

The solvent may suitably be selected from one or more of polar or non-polar solvents that may substantially dissolve at least one compound selected from: lithium sulfide, phosphorus sulfide, halogen compound and copper compound. Said solvent may also substantially suspend, dissolve or otherwise admix the above described components, e.g., lithium sulfide, phosphorus sulfide, halogen compound and copper compound.

Solvent of the invention then constitutes in step a) a continuous phase with dispersion of one or more of the above described components.

Depending on the components and the solvent, some of the components are then rather dissolved, partially dissolved or under a form of a slurry.(ie. component(s) is/are not dissolved and forming then a slurry with the solvent).

In certain preferred aspect, the solvent may suitably a polar solvent. Solvents are preferably polar solvents preferably selected in the group consisting of alkanols, notably having 1 to 6 carbon atoms, such as methanol, ethanol, propanol and butanol; carbonates, such as dimethyl carbonate; acetates, such as ethyl acetate; ethers, such as dimethyl ether; organic nitriles, such as acetonitrile; aliphatic hydrocarbons, such as hexane, pentane, 2-ethylhexane, heptane, decane, and cyclohexane; and aromatic hydrocarbons, such as tetrahydrofuran, xylene and toluene.

It is understood that references herein to “a solvent” includes one or more mixed solvents.

An amount of about 1 wt% to 80 wt% of the powder mixture and an amount of about 20 wt% to 99 wt% of the solvent, based on the total weight of the powder mixture and the solvent, may be mixed. Preferably, an amount of about 25 wt% to 75 wt% of the powder mixture and an amount of 25 wt% to 75 wt % of the solvent, based on the total weight of the powder mixture and the solvent, may be mixed. Particularly, an amount of about 40 wt % to 60 wt % of the powder mixture and an amount of about 40 wt % to 60 wt % of the solvent, based on the total weight of the powder mixture and the solvent, may be mixed.

The temperature of step a) in presence of solvent is preferably between the fusion temperature of the selected solvent and ebullition temperature of the selected solvent at a temperature where no unwanted reactivity is found between solvent and admixed compounds. Preferably step a) is done between -20° C. and 40° C. and more preferably between 15° C. and 40° C. In absence of solvent step a) is done at a temperature between -20° C. and 200° C. and preferably between 15° C. and 40° C. Duration of step a) is preferably between 1 minute and 1 hour.

Mechanical treatment to the composition in step b) may be performed by wet or dry milling; notably be performed by adding the powder mixture to a solvent and then milling at about 100 rpm to 1000 rpm, notably for a duration from 10 minutes to 80 hours more preferably for about 4 hours to 40 hours.

Said milling is also known as reactive-milling in the conventional synthesis of lithium argyrodites.

The mechanical milling method also has an advantage that, simultaneously with the production of a glass mixture, pulverization occurs. In the mechanical milling method, various methods such as a rotation ball mill, a tumbling ball mill, a vibration ball mill and a planetary ball mill or the like can be used. Mechanical milling may be made with or without balls such as ZrO₂.

In such a condition, lithium sulfide, phosphorous sulfide, halogen compound and copper compound are allowed to react in a solvent for a predetermined period of time.

The temperature of step b) in presence of solvent is between the fusion temperature of the selected solvent and ebullition temperature of the selected solvent at a temperature where no unwanted reactivity is found between solvent and compounds. Preferably step b) is done at a temperature between -20° C. and 80° C. and more preferably between 15° C. and 40° C. In absence of solvent step a) is done between -20° C. and 200° C. and preferably between 15° C. and 40° C.

Mechanical treatment to the composition in step b) may also be performed by stirring, notably by using well known techniques in the art, such as by using standard powder or slurry mixers.

Usually a paste or a blend of paste and liquid solvent may be obtained at the end of step b).

In step c), at least a portion of the solvent is removed notably means to remove at least about 30%, 40%, 50%, 60%, 70%, 80%, 90% 95% or 100%, of the total weight of a solvent used, or any ranges comprised between these values. Solvent removal may be carried out by known methods used in the art, such as decantation, filtration, centrifugation, drying or a combination thereof.

The temperature in step c) is selected to allow removal of solvent. Preferably when drying is selected as method for solvent removal, temperature is selected below ebullition temperature and as a function of vapor partial pressure of the selected solvent.

Duration of step c) is between 1 second and 100 hours, preferably between 1 hour and 20 hours. Such a low duration may be obtained for instance by using a flash evaporation, such as by spray drying.

It is preferred that step c) be conducted under an atmosphere of an inert gas such as nitrogen or argon. The dew point of an inert gas is preferably -20° C. or less, particularly preferably -40° C. or less. The pressure may be from 0.0001 Pa to 100 MPa, preferably from 0.001 Pa to 20 MPa, preferably from 0.01 Pa to 20 MPa. Notably the pressure may range from 0.0001 Pa to 0.001 Pa, notably by using ultravacuum techniques. Notably the pressure may range from 0,01 Pa to 0,1 MPa by using primary vacuum techniques.

In step d) the heating, or thermal treatment, may notably allow to convert the amorphized powder mixture (glass) obtained above into a solid material crystalline or mixture of glass and crystalline (glass ceramics).

Heat treatment is carried out at a temperature in the range of from 100° C. to 700° C., preferably from 250° C. to 600° C., notably for a duration of 1 minute to 100 hours, preferably from 30 minutes to 20 hours. Heat treatment may start directly at high temperature or via a ramp of temperature at a rate comprised between 1° C./min to 20° C./min. Heat treatment may finish with an air quenching or via natural cooling from the heating temperature or via a controlled ramp of temperature at a rate comprised between 1° C./min to 20° C./min.

Preferably in step d), inert atmosphere comprises an inter gas such as dry N₂, or dry Argon (dry may refer to a gas with less than 800 ppm of liquid and airborne forms of water, including condensation). Preferably in step d) the inert atmosphere is a protective gas atmosphere used in order to minimize, preferably exclude access of oxygen and moisture.

The pressure at the time of heating may be at normal pressure or under reduced pressure. The atmosphere may be inert gas, such as nitrogen and argon. The dew point of the inert gas is preferably -20° C. or less, with -40° C. or less being particularly preferable. The pressure may be from to 100 MPa, preferably from 0.001 Pa to 20 MPa, preferably from 0,01 Pa to 20 MPa. Notably the pressure may range from 0.0001 Pa to 0.001 Pa, notably by using ultravacuum techniques. Notably the pressure may range from 0.01 Pa to 0.1 MPa by using primary vacuum techniques.

In step e), it is possible to treat the solid material to the desired particle size distribution. If necessary, the solid material obtained by the process according to the invention as described above is ground (e.g. milled) into a powder. Preferably, said powder has a D50 value of the particle size distribution of less than 100 µm, more preferably less than 10 µm, most preferably less than 5 µm, as determined by means of dynamic light scattering or image analysis.

Preferably, said powder has a D90 value of the particle size distribution of less than 100 µm, more preferably less than 10 µm, most preferably less than 5 µm, as determined by means of dynamic light scattering or image analysis. Notably, said powder has a D90 value of the particle size distribution comprised from 1 µm to 100.

The invention then also refers to a process for the preparation of a solid material according to general formula (I), said process comprising at least the process steps of:
a′) obtaining a solution by admixing stoichiometric amounts of lithium compounds, sulfide compounds, phosphorous compounds, halogen compound and a copper compound, in one or more solvents, under an inert atmosphere;
b′) removing at least a portion of the one or more solvents from the composition as obtained in step a′), so that to obtain a solid material;
c′) optionally heating the solid material as obtained in step b′), at a temperature in the range of from 100° C. to 700° C., under an inert atmosphere; and
d′) optionally treating the solid material obtained in step c′) to the desired particle size distribution.

Various features of step a′) are basically similar to those of step a), such as for instance with respect to precursors and solvent. Preferably temperature in step a) ranges from -200° C. to 100° C., preferably from -200° C. to 10° C.

Features in the removal of solvent as mentioned in step b′) may be similar to those ones as expressed in step c). Preferably in step b′), temperature is in the range of from 30° C. to 200° C., under an inert atmosphere, and preferably under a pressure 0.0001 Pa to 100 MPa.

Heating of step c′) may be carried out with features as expressed in step d). Preferably at a temperature in the range of from 100° C. to 700° C., under an inert atmosphere and preferably under a pressure 0.0001 Pa to 100 MPa.

Features of treating the solid material as mentioned in step d′) may be similar to those ones as expressed in step e).

The invention also refers to a solid material of formula (I) as solid electrolyte, as well as a solid electrolyte comprising at least a solid material of formula (I).

Said solid electrolytes comprises then at least a solid material of formula (I) and optionally an other solid electrolyte, such as a lithium argyrodites, lithium thiophosphates, such as glass or glass ceramics Li₃PS₄, Li₇PS₁₁, and lithium conducting oxides such as lithium stuffed garnets Li₇La₃Zr₂O₁₂ (LLZO), sulfide.

Said solid electrolytes may also optionally comprise polymers such as styrene butadiene rubbers, organic or inorganic stabilizers such as SiO₂ or dispersants.

The invention also concerns an electrochemical device comprising a solid electrolyte comprising at least a solid material of formula (I).

Preferably in the electrochemical device, particularly a rechargeable electrochemical device, the solid electrolyte is a component of a solid structure for an electrochemical device selected from the group consisting of cathode, anode and separator.

Herein preferably the solid electrolyte is a component of a solid structure for an electrochemical device, wherein the solid structure is selected from the group consisting of cathode, anode and separator. Accordingly, the solid materials according to the invention can be used alone or in combination with additional components for producing a solid structure for an electrochemical device, such as a cathode, an anode or a separator.

The electrode where during discharging a net negative charge occurs is called the anode and the electrode where during discharging a net positive charge occurs is called the cathode. The separator electronically separates a cathode and an anode from each other in an electrochemical device.

Suitable electrochemically active cathode materials and suitable electrochemically active anode materials are well known in the art. In an electrochemical device according to the invention, the anode preferably comprises graphitic carbon, metallic lithium, silicon compounds such as Si, SiOₓ, lithium titanates such as Li₄Ti₅O₁₂ or a metal alloy comprising lithium as the anode active material such as Sn.

In an electrochemical device according to the invention, the cathode preferably comprises a metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0 < x < 1), and spinel-structured LiMn₂O₄. Another preferred examples thereof may include lithium-nickel-manganese-cobalt-based metal oxide of formula LiNiₓMn_{y}Co_{z}O₂ (x+y+z=1, referred to as NMC), for instance LiNi_{⅓}Mn_{⅓}Co_{⅓}O₂, LiNi_{0.6}Mn_{0.2}Co_{0.2}O₂, and lithium-nickel-cobalt-aluminum-based metal oxide of formula LiNiₓCo_{y}Al_{z}O₂ (x+y+z = 1, referred to as NCA), for instance LiNi_{0.8}Co_{0.15}Al_{0.05}O₂. Cathode may comprise a lithiated or partially lithiated transition metal oxyanion-based material such as LiFePO₄.

For example, the electrochemical device has a cylindrical-like or a prismatic shape. The electrochemical device can include a housing that can be from steel or aluminum or multilayered films polymer/metal foil.

A further aspect of the present invention refers to batteries, more preferably to an alkali metal battery, in particular to a lithium battery comprising at least one inventive electrochemical device, for example two or more. Electrochemical devices can be combined with one another in inventive alkali metal batteries, for example in series connection or in parallel connection.

The invention also concerns a solid state battery comprising a solid electrolyte comprising at least a solid material of formula (I).

Typically, a lithium solid-state battery includes a positive electrode active material layer containing a positive electrode active material, a negative electrode active material layer containing a negative electrode active material, and a solid electrolyte layer formed between the positive electrode active material layer and the negative electrode active material layer. At least one of the positive electrode active material layer, the negative electrode active material layer, and the solid electrolyte layer includes a solid electrolyte as defined above.

The cathode of an all-solid-state electrochemical device usually comprises beside an active cathode material as a further component a solid electrolyte. Also the anode of an all-solid state electrochemical device usually comprises a solid electrolyte as a further component beside an active anode material.

The form of the solid structure for an electrochemical device, in particular for an all-solid-state lithium battery, depends in particular on the form of the produced electrochemical device itself. The present invention further provides a solid structure for an electrochemical device wherein the solid structure is selected from the group consisting of cathode, anode and separator, wherein the solid structure for an electrochemical device comprises a solid material according to the invention.

A plurality of electrochemical cells may be combined to an all solid-state battery, which has both solid electrodes and solid electrolytes.

The solid material disclosed above may be used in the preparation of an electrode. The electrode may be a positive electrode or a negative electrode.

The electrode typically comprises at least:
a metal substrate;
directly adhered onto said metal substrate, at least one layer made of a composition comprising:
(i) a solid material of formula (I) as follows:
$${\text{Li}}_{6 \text{-x-2y}} {\text{Cu}}_{\text{x}} {\text{PS}}_{5 \text{-y}} \text{X}$$
wherein:
X is selected from the group consisting of: F, Cl, I and Br;
0.005 ≤ x ≤ 5; preferably 0.015 ≤ x ≤ 1.5; and
0 ≤ y ≤ 0.5., preferably 0 ≤ y ≤ 0.25.;

(ii) at least one electro-active compound (EAC);
(iii) optionally at least one lithium ion-conducting material (LiCM) other than the solid material of the invention;
(iv) optionally at least one electro-conductive material (ECM);
(v) optionally a lithium salt (LIS);
(vi) optionally at least one polymeric binding material (P).

The electro-active compound (EAC) denotes a compound which is able to incorporate or insert into its structure and to release lithium ions during the charging phase and the discharging phase of an electrochemical device. An EAC may be a compound which is able to intercale and deintercalate into its structure lithium ions. For a positive electrode, the EAC may be a composite metal chalcogenide of formula LiMeQ₂ wherein:
Me is at least one metal selected in the group consisting of Co, Ni, Fe, Mn, Cr, Al and V;
Q is a chalcogen such as O or S.

The EAC may more particularly be of formula LiMeO₂. Preferred examples of EAC include LiCoO₂, LiNiO₂, LiMnO₂, LiNiₓCo₁₋ₓO₂ (0 < x < 1), LiNiₓCo_{y}Mn_{z}O₂ (0 < x, y, z < 1 and x+y+z=1) for instance LiNi_{⅓}Mn_{⅓}Co_{⅓}O₂, LiNi_{0,6}Mn_{0,2}Co_{0,2}O₂, LiNi_{0.8}Mn_{0.1}Co_{0.1}O₂, Li(NiₓCo_{y}Al_{z})O₂ (x+y+z=1) and spinel-structured LiMn₂O₄ and Li (Ni_{0.5}Mn_{1.5})O₄.

The EAC may also be a lithiated or partially lithiated transition metal oxyanion-based electro-active material of formula M₁M₂(JO₄)_{f}E_{1-f}, wherein:
M₁ is lithium, which may be partially substituted by another alkali metal representing less that 20% of M₁;
M₂ is a transition metal at the oxidation level of +2 selected from Fe, Co, Mn, Ni or mixtures thereof, which may be partially substituted by one or more additional metals at oxidation levels between +1 and +5 and representing less than 35% of the M₂ metals, including 0;
JO₄ is any oxyanion wherein J is either P, S, V, Si, Nb, Mo or a combination thereof;
E is a fluoride, hydroxide or chloride anion;
f is the molar fraction of the JO₄ oxyanion, generally comprised between 0.75 and 1.

The M₁M₂(JO₄)_{f}E_{1-f} electro-active material as defined above is preferably phosphate-based. It may exhibit an ordered or modified olivine structure.

For a positive electrode, the EAC may also be sulfur or Li₂S.

For a positive electrode , the EAC may also be a conversion-type materials such as FeS₂ or FeF₂ or FeF₃

For a negative electrode, the EAC may be selected in the group consisting of graphitic carbons able to intercalate lithium. More details about this type of EAC may be found in Carbon 2000, 38, 1031-1041. This type of EAC typically exist in the form of powders, flakes, fibers or spheres (e.g. mesocarbon microbeads).

The EAC may also be: lithium metal; lithium alloy compositions (e.g. those described in US 6,203,944 and in WO 00/03444); lithium titanates, generally represented by formula Li₄Ti₅O₁₂; these compounds are generally considered as “zero-strain” insertion materials, having low level of physical expansion upon taking up the mobile ions, i.e. Li⁺; lithium-silicon alloys, generally known as lithium silicides with high Li/Si ratios, in particular lithium silicides of formula Li_{4.4}Si and lithium-germanium alloys, including crystalline phases of formula Li_{4.4}Ge. EAC may also be composite materials based on carbonaceous material with silicon and/or silicon oxide, notably graphite carbon/silicon and graphite/silicon oxide, wherein the graphite carbon is composed of one or several carbons able to intercalate lithium.

The ECM is typically selected in the group consisting of electro-conductive carbonaceous materials and metal powders or fibers. The electron-conductive carbonaceous materials may for instance be selected in the group consisting of carbon blacks, carbon nanotubes, graphite, graphene and graphite fibers and combinations thereof. Examples of carbon blacks include ketjen black and acetylene black. The metal powders or fibers include nickel and aluminum powders or fibers.

The lithium salt (LIS) may be selected in the group consisting of LiPF₆, lithium bis(trifluoromethanesulfonyl)imide , lithium bis(fluorosulfonyl)imide, LiB(C₂O₄)₂, LiAsF₆, LiClO₄, LiBF₄, LiAlO₄, LiNO₃, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiCF₃SO₃, LiAlCl₄, LiSbF₆, LiF, LiBr, LiCl, LiOH and lithium 2-trifluoromethyl-4,5-dicyanoimidazole.

The function of the polymeric binding material (P) is to hold together the components of the composition. The polymeric binding material is usually inert. It preferably should be also chemically stable and facilitate the electronic and ionic transport. The polymeric binding material is well known in the art. Non-limitative examples of polymeric binder materials include notably, vinylidenefluoride (VDF)-based (co)polymers, styrene-butadiene rubber (SBR), styrene-ethylene-butylene-styrene (SEBS), carboxymethylcellulose (CMC), polyamideimide (PAI), poly(tetrafluoroethylene) (PTFE) and poly(acrylonitrile) (PAN) (co)polymers.

The proportion of the solid material of the invention in the composition may be between 0.1 wt% to 80 wt%, based on the total weight of the composition. In particular, this proportion may be between 1.0 wt% to 60 wt%, more particularly between 5 wt% to 30 wt%. The thickness of the electrode is not particularly limited and should be adapted with respect to the energy and power required in the application. For example, the thickness of the electrode may be between 0.01 mm to 1,000 mm.

The inorganic material M may also be used in the preparation of a separator. A separator is an ionically permeable membrane placed between the anode and the cathode of a battery. Its function is to be permeable to the lithium ions while blocking electrons and assuring the physical separation between the electrodes.

The separator of the invention typically comprises at least:
a solid material of formula (I) as follows:
$${\text{Li}}_{6 \text{-x-2y}} {\text{Cu}}_{\text{x}} {\text{PS}}_{5 \text{-y}} \text{X}$$
wherein:
X is selected from the group consisting of: F, Cl, I and Br;
0.005 ≤ x ≤ 5; preferably 0.015 ≤ x ≤ 1.5; and
0 ≤ y ≤ 0.5, preferably 0 ≤ y ≤ 0.25;
optionally at least one polymeric binding material (P);
optionally at least one metal salt, notably a lithium salt;
optionally at least one plasticizer.

The electrode and the separator may be prepared using methods well-known to the skilled person. This usually mixing the components in an appropriate solvent and removing the solvent. For instance, the electrode may be prepared by the process which comprises the following steps:
a slurry comprising the components of composition and at least one solvent is applied onto the metal substrate;
the solvent is removed.

Usual techniques known to the skilled person are the following ones: coating and calendaring, dry and wet extrusion, 3D printing, sintering of porous foam followed by impregnation. Usual techniques of preparation of the electrode and of the separator are provided in Journal of Power Sources, 2018 382, 160-175.

The electrochemical devices, notably batteries such as solid state batteries described herein, can be used for making or operating cars, computers, personal digital assistants, mobile telephones, watches, camcorders, digital cameras, thermometers, calculators, laptop BIOS, communication equipment or remote car locks, and stationary applications such as energy storage devices for power plants.

The electrochemical devices, notably batteries such as solid state batteries described herein, can notably be used in motor vehicles, bicycles operated by electric motor, robots, aircraft (for example unmanned aerial vehicles including drones), ships or stationary energy storages. Preferred are mobile devices such as are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

Should the disclosure of any patents, patent applications, and publications which are incorporated herein by reference conflict with the description of the present application to the extent that it may render a term unclear, the present description shall take precedence.

### FIGURES

FIG. 1: powder XRD pattern of Li_{6-x-2y}CuₓPS_{5-y}Cl. Sample A : x=0; sample B : x=0.03; sample C : x=0.06; sample D : x=0.3; sample E : x=0.6; sample F : x=1.5.

FIG. 2: ³¹P NMR data of Li_{6-x-2y}CuₓPS_{5-y}Cl with x=0.3 and y=0. Star symbol indicates the signature of PS₄³⁻ entities, Pentagon symbol indicates the signature of P₂S₇⁴⁻ entities, and Hexagon symbol indicates the signature of PO₄³⁻ entities.

FIG. 3: ⁷Li NMR data of Li_{6-x-2y}CuₓPS_{5-y}Cl with x=0.3 and y=0.

### EXPERIMENTAL PART

The examples below serve to illustrate the invention, but have no limiting character.

### X-Ray Diffraction

The XRD diffractograms of the powders were acquired on a XRD goniometer in the Bragg Brentano geometry, with a Cu X Ray tube (Cu Kalpha wavelength of 1.5406 Å). The setup may be used in different optical configurations, i.e. with variable or fixed divergence slits, or Soller slits. A filtering device on the primary side may also be used, like a monochromator or a Bragg Brentano HD optics from Panalytical. If variable divergence slits are used; the typical illuminated area is 10 mm × 10 mm. The sample holder is loaded on a spinner; rotation speed is typically 60 rpm during the acquisition. Tube settings were operating at 40 kV/30 mA for variable slits acquisition and at 45 kV/40 mA for fixed slits acquisition with incident Bragg Brentano HD optics. Acquisition step was 0.017° per step. Angular range is typically 5° to 90° in two theta or larger. Total acquisition time was typically 30 min or longer. The powders are covered by a Kapton film to prevent reactions with air moisture.

### Conductivity & Electrochemical Impedance Spectroscopy (EIS)

The conductivity was acquired on pellets done using a uniaxial press operated at 500 MPa. The measurement is done under a loading of 40 MPa and two carbon paper foils are used as current collector in a pressure cell from MTI (BATTE-CELL-0067 EQ-PSC-15-P). The impedance spectra are acquired on a Biologic VMP3 device and the control of temperature is ensured by a Binder climatic chamber. Duration of two hours is set to allow the temperature to be equilibrated between two measurements. Impedance spectroscopy is acquired in PEIS mode with an amplitude of 10 mV and a range of frequencies from 1 MHz to 1 kHz (25 points per decade and a mean of 50 measurements per frequency point.)

### Solid-State NMR

Solid-State NMR spectra were recorded on a Bruker Avance 400 spectrometer equipped with a high-speed DVT4 probe. ³¹P and ⁶Li measurements were performed by magic-angle-spinning (MAS) at a speed of 10 kHz, in single-pulse mode with a relaxation time D1 depending on the experiment (see example below). ⁷Li measurements were performed in the static, single-pulse mode with a relaxation time D1 = 120 s. Reference for ³¹P NMR was 85% H₃PO₄, for ⁶Li NMR a 5 mol L⁻¹ aqueous LiCl solution.

### Example 1: Synthesis

The weighing of precursors and preparation of the sample is carried out in an Ar-filled glovebox with oxygen and moisture levels both below 1 ppm. In a typical experiment, a 30 mL glass vial is used to weight Li₂S (≥ 99.9 %, Albemarle), P₂S₅ (≥ 99%, Sigma Aldrich), LiCl (≥ 99%, Sigma Aldrich) and Cu₂S (≥ 99.5%, Alfa Aesar) according to the target stoichiometry Li_{6-x-2y}CuₓPS_{5-y}Cl (0.015 ≤ x ≤ 1.5 and 0 ≤ y ≤ 0.25) (total mass of 8 g). For instance for a solid material Li_{5.94}Cu_{0.06}PS₅Cl (x=0.06 and y=0) 3.34 g of Li₂S, 3.27 g of P₂S₅, 1.25 g of LiCl and 0.14 g of Cu₂S have been used. Precursors used here are powders having an average particle diameter comprised between 10 µm and 400 µm.

The glass vial is hermetically closed, removed from the glovebox and mixed with a Turbula mixer for 20 min. The glass vial is entered in the glovebox and the sample is poured in a 45 mL ZrO₂ milling jar which contains 66.4 g of diameter ∅5 mm ZrO₂ balls. Then 8 g of p-xylene (≥ 99%, Sigma-Aldrich, anhydrous) is added in the jar. The jar is equipped with a Viton seal and hermetically closed with Ar atmosphere inside the jar. The jar is removed from the glovebox and set inside a planetary ball-milling (Pluverisette 7 premium line, Fritsch). The mechanosynthesis is carried out at 800 rpm during 80 cycles of 15 min. Between each cycle the jar is naturally cooled for 30 min.

After the end of the mechanosynthesis the jar is entered in the glovebox. The product and the balls are set inside two 30 mL glass vials (without caps) placed themselves in a glass tube. The tube is closed, removed from the glovebox and set in a Glass Oven B-585 from Büchi. The sample is dried under vacuum for 2 h at room temperature (25° C.) and subsequently heated to 110° C. for 5 h to evaporate the p-xylene. Thereafter, the tube is closed (vacuum inside) and entered in the glovebox. The powder is sieved and separated from the milling balls. The powder is set inside a 30 mL glass vial without caps placed itself in a glass tube. The tube is closed, removed from the glovebox and set in a Glass Oven B-585 from Büchi. The sample is heated under vacuum at 150° C. for 1 h, followed by 1 h at 280° C. and finally heated at 300° C. for 12 h. The tube is closed (vacuum inside) and entered in the glovebox. The sample is removed from the tube and stored for the further analyses.

### Example 2 : Properties

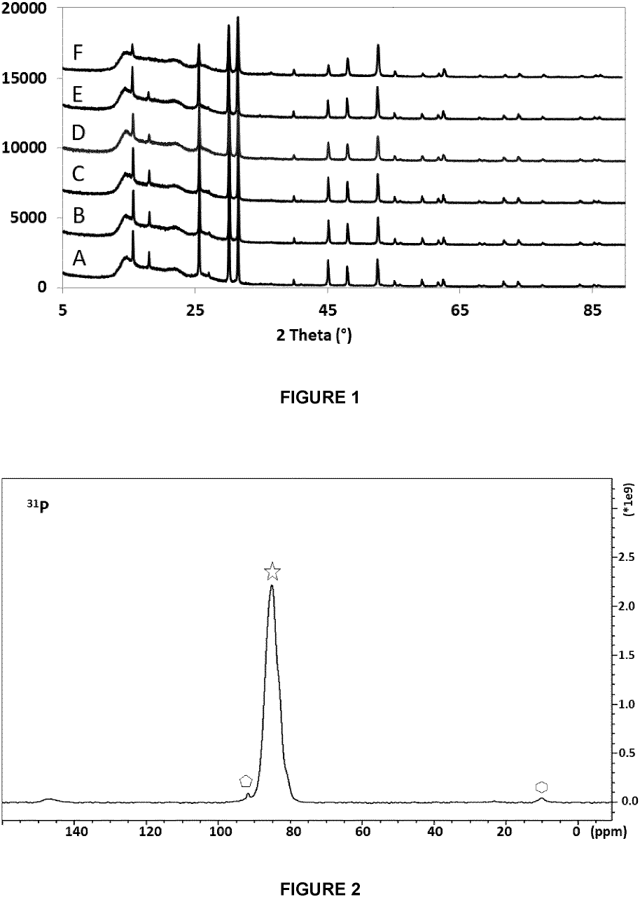

Whatever the composition is in the selected range, the powder XRDs (FIG. 1) indicate the predominance of the argyrodite phase with a minute amount of Li₂S when x ≤ 0.06. No copper containing impurities can be seen from powder XRDs, even for the higher copper content of the selected range (x = 1.5). The powder XRDs also show that the increase of copper content (x) decreases the amount of Li₂S impurity.

Cell parameters were calculated using a Le Bail refinement, on kapton substrated diffractogram. This was done using Fullprof software.

| | |
|---|---|
| X value | Cell parameter |
| x=0 | 9,857 Angstrom |
| x=0.03 | 9,848 Angstrom |
| x=0.06 | 9,848 Angstrom |
| x=0.3 | 9,844 Angstrom |
| x=0.6 | 9,831 Angstrom |
| x=1.5 | 9,810 Angstrom |

The ³¹P NMR (FIG. 2) of the x = 0.3 sample corroborates the predominance of PS₄³⁻ species with a minute amount of P₂S₇⁴⁻ and potentially a low amount of Li₃PO₄ impurity.

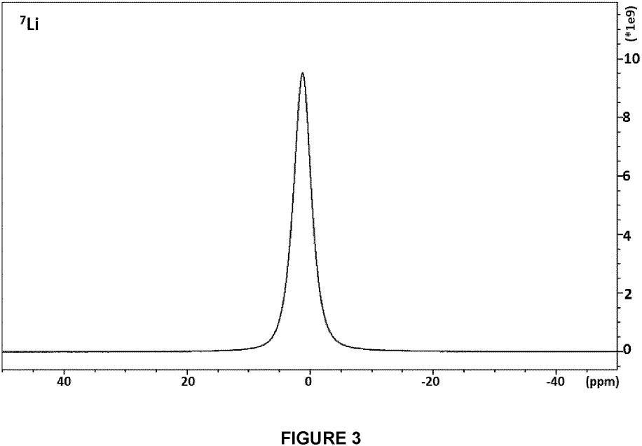

The ⁷Li NMR (FIG. 3) of the x = 0.3 sample indicates the presence of a single Li environment, with a displacement close to 1.38 ppm, in very good agreement with the displacement of the Li₆PS₅Cl phase found in the literature.

The Electrochemical Impedance Spectroscopy measurements were carried out on 6 mm diameter pellets, densified under 500 MPa. The thickness of the pellet is close to 1 mm. The EIS measurements indicate that a small copper content increases the conductivity of the material. Thus, the samples with 0.03 ≤ x ≤ 0.06 benefit of a higher conductivity than the x = 0 sample. Furthermore, the activation energy of the samples with 0.03 ≤ x ≤ 0.06 remains below 0.40 eV between -20° C. and 60° C. For higher copper content (x ≥ 0.3) the conductivity decreases and the activation energy increases as expressed in the table below:

| X value | Li_{6-x-2y}CuₓPS_{5-y}Cl (%*) | Li₂S (%*) | LiCl (%*) | Conductivity at 30° C. (S cm⁻¹) | Ea (eV) |
|---|---|---|---|---|---|
| x=0 | 94.5 | 4.4 | 1.1 | 2.06×10⁻³ | 0.37 |
| x=0.03 | 96.8 | 3.2 | 0 | 2.83×10⁻³ | 0.37 |
| x=0.06 | 96.3 | nm | 0 | nm | 0.40 |
| x=0.3 | 100 | 0 | 0 | nm | nm |

%* corresponds to the portion of crystallized product among total crystalline phase as measured by peak areas
Nm is non-measured

1. A solid material according to general formula (I) as follows: 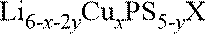
wherein:
X is selected from the group consisting of F, Cl, I and Br;
0.005 ≤ x ≤ 5; and
0 ≤ y ≤ 0.5..

2. The solid material according to claim 1 wherein X is Cl.

3. The solid material according to claim 1 wherein 0.02 ≤ x ≤ 0.8.

4. The solid material according to claim 1
wherein the crystallization degree of the solid material is from 80% to 100%.

5. The solid material according to claim 1
wherein the solid material comprises at least peaks at position of: 15.65°+/- 0.5°, 25.53°+/-0.5°, 30.16°+/- 0.5°, and 31.52°+/- 0.5° (2θ) when analyzed by x-ray diffraction using CuKα radiation at 25° C.

6. The solid material according to claim 1
wherein it is in powder form with a distribution of particle diameters having a D50 between 0.05 µm and 10 µm.

7. A method for producing the solid material according to claim 1 comprising at least bringing at least lithium sulfide, phosphorous sulfide, halogen compound and a copper compound, optionally in one or more solvents.

8. A process for the preparation of a solid material according to claim 1 comprising at least the process steps of:
a) obtaining a composition by admixing stoichiometric amounts of lithium sulfide,
phosphorous sulfide, halogen compound and a copper compound, optionally in one or more solvents, under an inert atmosphere;
b) applying a mechanical treatment to the composition obtained in step a);
c) optionally removing at least a portion of the one or more solvents from the composition obtained on step b), so that to obtain a solid residue;
d) heating the obtained residue obtained in step c) at a temperature in the range of from 100° C. to 700° C., under an inert atmosphere, thereby forming the solid material; and
e) optionally treating the solid material obtained in step d) to the desired particle size distribution.

9. The process according to claim 8 wherein the copper compound is selected from the group consisting of CuS, Cu₂S, Cu₂₋ₓS (wherein x is between 0 and 1 and CuCl₂.

10. The process according to claim 8wherein the lithium sulfide is Li₂S, the phosphorous sulfide is P₂S₅, the halogen compound is LiCl, and the copper compound is Cu₂S.

11. The process according to claim 8 wherein the solvent is selected in the group consisting of alkanols; carbonates; acetates; ethers; organic nitriles; aliphatic hydrocarbons; and aromatic hydrocarbons.

12. The process according to claim 8
wherein in step b) the mechanical treatment is performed by wet or dry milling.

13. (canceled)

14. A process for the preparation of a solid material according to claim 1, said process comprising at least the process steps of:
a′) obtaining a solution by admixing stoichiometric amounts of lithium compounds, sulfide compounds, phosphorous compounds, halogen compound and a copper compound, in one or more solvents, under an inert atmosphere;
b′) removing at least a portion of the one or more solvents from the composition as obtained in step a′), so that to obtain a solid material;
c′) optionally heating the solid material as obtained in step b′), at a temperature in the range of from 100° C. to 700° C., under an inert atmosphere; and
d′) optionally treating the solid material obtained in step c′) to the desired particle size distribution.

15. (canceled)

16. (canceled)

17. A solid electrolyte comprising at least a solid material of formula (I) as follows: 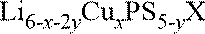
wherein:
X is selected from the group consisting of F, Cl, I and Br;
0.005 ≤ x ≤ 5; and
0 ≤ y ≤ 0.5..

18. An electrochemical device comprising at least the solid electrolyte of claim 17.

19. A solid state battery comprising at least the solid electrolyte of claim 17.

20. A vehicle comprising at least a solid state battery comprising at least the solid electrolyte of claim 17.

21. An electrode comprising at least:
a metal substrate;
directly adhered onto said metal substrate, at least one layer made of a composition comprising:
(i) a solid material of formula (I) as follows: 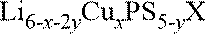
wherein:
X is selected from the group consisting of F, Cl, I and Br;
0.005 ≤ x ≤ 5; and
0 ≤ y ≤ 0.5;
(ii) at least one electro-active compound (EAC);
(iii) optionally at least one lithium ion-conducting material (LiCM) other than the solid material of formula (I);
(iv) optionally at least one electro-conductive material (ECM);
(v) optionally a lithium salt (LIS);
(vi) optionally at least one polymeric binding material (P).

22. A separator comprising at least:
the solid material of claim 1
optionally at least one polymeric binding material (P);
optionally at least one metal salt, notably a lithium salt;
optionally at least one plasticizer.
